(19) United States
(12) Patent Application Publication
(10) Pub. No.: US 2014/0179307 A1
(43) Pub. Date: Jun. 26, 2014

(54) RECORDS EXCHANGE SYSTEM AND METHOD THEREFOR

(71) Applicant: TATA COMMUNICATIONS (AMERICA) INC., Herndon, VA (US)

(72) Inventors: NING SO, Plano, TX (US); Brian Pebbles, Cranford, NJ (US)

(73) Assignee: TATA COMMUNICATIONS (AMERICA) INC., Herndon, VA (US)

(21) Appl. No.: 13/724,956

(22) Filed: Dec. 21, 2012

(51) Int. Cl. H04W 8/20

(52) U.S. Cl. CPC H04W 8/20
USPC 455/432.1

(57) ABSTRACT

A records exchange system and method comprises a data processing system that receives selected mobile subscriber data for mobile subscribers, filters the data based on data exchange packages that are established pursuant to agreements with third parties, and transmits the filtered data to the third parties.

### FIELD OF THE INVENTION

The present invention relates to wireless telecommunications, and more particularly to an exchange by which data can be shared between mobile network operators and other parties.

### BACKGROUND OF THE INVENTION

A mobile network operator keeps detailed records about its mobile subscribers. These records include account information, user device information, personal information, and usage records. With this information, the mobile network operator can make a variety of determinations regarding a mobile subscriber's use of the network, including access issues, usage issues, optimal routing, and the like.

The mobile subscriber's records are accessible only by the mobile subscriber's home mobile network operator. This is due to privacy issues, among any other reasons. The lack of records access outside the home network has severely curtailed mobile broadband (data) service roaming capabilities. In the absence of mobile broadband data service roaming agreements, mobile network operators tend to lose revenue and even customers due to vigorous competition.

### SUMMARY OF THE INVENTION

The present invention provides a way to present confidential information, such as mobile subscriber information, to a party that would normally have quite limited access to such information. The illustrative embodiment of the present invention is a Records Exchange System and methods for records exchange.

The capability to deliver at least some of the typically highly confidential information of a mobile subscriber to another entity, such as a third-party mobile network operator, enables new approaches to roaming. These new approaches offer the promise of better customer retention and potentially more revenue. Furthermore, the ability to present mobile subscriber information to an advertiser, for example, provides the advertiser with an ability to pick an audience of mobile subscribers based on specific selection criteria, as gleaned from the subscriber records. Assuming the selection criteria are well chosen, the advertiser can expect an increase hit rate. In other words, this “targeted” audience should be more likely to respond positively to the ad than if it were broadcast to a random group of subscribers. Additionally, embodiments of the present invention provide a platform for offering hosted policy services to mobile network operators. Such a platform can provide significant cost savings to mobile network operators in terms of infrastructure and administration costs.

In accordance with the illustrative embodiment, the Record Exchange System is implemented as a data processing system, including a transceiver, a processor, and processor-accessible storage.

In the illustrative embodiment, the Record Exchange System receives selected mobile subscriber records that are transmitted thereto from the subscriber's mobile network operator via, for example, the internet. In some embodiments, the Record Exchange System stores the mobile subscriber records in a block of secure storage. Each mobile network operator that utilizes the Records Exchange System is allocated its own block of secure storage within the processor-accessible storage.

The processor of the Record Exchange System executes specialized software that “filters” the mobile subscriber records so that only certain information is revealed to the parties interested in receiving the records. Parties that might receive the filtered mobile subscriber data include, without limitation, other mobile network operators, virtually any entity wishing to advertise, a mobile advertising network, a mobile agency, an advertising publisher, and the like.

The information that is contained in the filtered mobile subscriber records depends on, among other considerations, the party that is to receive the filtered records. It can also depend upon the particular mobile subscriber. In some embodiments, to use the Records Exchange System, the operator establishes records exchange agreements with other third parties using the System. These agreements establish a framework for interaction between the mobile network operator and every third party wishing to receive filtered mobile subscriber data from the mobile network operator. Based on these agreements, “data exchange packages” (“DEPs”) are established. In some other embodiments, exchange agreements and corresponding DEPs are “automatically” established once a party opts-in to the Record Exchange System. In yet some further embodiments, if exchange agreements are not established among one or more parties of the Record Exchange System, a default agreement and corresponding DEP(s) are established that permits some limited amount of information to be exchanged as between those parties.

The data exchange packages define, among other items, what particular information within the mobile subscriber record that is available to the Records Exchange System (as provided by the mobile network operator) can be forwarded to any particular third party. In other words, the data exchange packages function as a “filter” so that some, but usually not all, of the information contained in the subscriber's record winds up in a “filtered” record destined for a third party. The filtered record provides a third party that receives it with information needed or desired in support of whatever service the third party is to provide to the mobile subscriber (e.g., roaming, etc.) or, more generally, whatever interest (e.g., targeted mobile advertising, etc.) the third party has in the mobile subscriber.

In a first embodiment, the invention provides a mobile subscriber Records Exchange System comprising a data processing system, wherein the data processing system includes:

a transceiver for sending signals to and receiving signals from a first participating party and at least a second participating party, wherein the first participating party is a first mobile network operator; and

a processor, wherein the processor executes the following tasks:
(i) filters selected mobile subscriber data for a first mobile subscriber of the first mobile network operator, wherein the selected mobile subscriber data is filtered using information contained in a first data exchange package applicable to the first mobile subscriber and the second party, the filtering thereby generating a first filtered mobile subscriber record; and
(ii) causes the transceiver to transmit a first outgoing signal to the second party, wherein the first outgoing signal conveys the first filtered mobile subscriber record.

In a second embodiment, the mobile subscriber Records Exchange System comprises, in addition to the elements of the first embodiment, processor-accessible storage, wherein the processor-accessible storage contains:
the selected mobile subscriber data for the first mobile subscriber; and
the first data exchange package.

In a third embodiment, the mobile subscriber Records Exchange System comprises, in addition to the elements of the first embodiment, the processor further executes the following tasks:
(iii) filters the selected mobile subscriber data for the first mobile subscriber using information contained in a second data exchange package applicable to the first mobile subscriber and a third participating party, the filtering thereby generating a second filtered mobile subscriber record; and
(iv) causes the transceiver to transmit a second outgoing signal to the third participating party, wherein the second outgoing signal conveys the second filtered mobile subscriber record.

In a fourth embodiment, the mobile subscriber Records Exchange System comprises, in addition to the elements of the third embodiment, processor-accessible storage, wherein the processor-accessible storage contains:
the selected mobile subscriber data for the first mobile subscriber;
the first data exchange package; and
the second data exchange package.

In a fifth embodiment, the invention provides a method for exchanging mobile subscriber records, wherein the method comprises:

receiving, at a data processing system, a first signal comprising selected mobile subscriber data for a first mobile subscriber from a first participating party;

filtering, in the data processing system, the selected mobile subscriber data using a first data exchange package that is applicable to the first mobile subscriber and a second participating party, thereby generating a first filtered mobile subscriber record;

filtering, in the data processing system, the selected mobile subscriber data using a second data exchange package that is applicable to the first mobile subscriber and a third participating party, thereby generating a second filtered mobile subscriber record;

transmitting, from the data processing system to the second participating party, the first filtered mobile subscriber record via a second signal; and

transmitting, from the data processing system to the third participating party, the second filtered mobile subscriber record via a third signal.

In a sixth embodiment, the method for exchanging mobile subscriber records comprises, in addition to the tasks of the fifth embodiment, storing the selected mobile subscriber data in a secure data base in the data processing system.

In a seventh embodiment, the method for exchanging mobile subscriber records comprises, in addition to the tasks of the fifth embodiment, storing the first data exchange package and the second data exchange package in a data base in the data processing system.

### BRIEF DESCRIPTION OF THE DRAWINGS

FIG. 1 depicts Records Exchange System 100 in accordance with the illustrative embodiment of the present invention.

FIG. 2A depicts a block diagram of an illustrative hardware platform for the Records Exchange System of FIG. 1.

FIG. 2B depicts a flow diagram of a method in accordance with the illustrative embodiment of the present invention.

FIG. 3 depicts content within processor-accessible storage of the Records Exchange System of FIG. 1.

FIG. 4 depicts further details about the content of processor-accessible storage shown in FIG. 3.

FIG. 5 depicts a functional illustration of data exchange packages.

FIG. 6 depicts an illustration of a filtering function of the data exchange packages of FIG. 5.

FIG. 7 depicts a method for filtering mobile subscriber records, in accordance with the illustrative embodiment of the present invention, using a record abstraction process of the Records Exchange System of FIG. 1.

FIG. 8 depicts various tasks conducted by the Records Exchange System in response to receiving certain information from Participating Parties.

FIG. 9 depicts tasks performed by a home mobile network operator, the Records Exchange System, and other Parties in an embodiment for implementing the method of FIG. 2B.

FIGS. 10 through 15 depict an example of the use the Records Exchange System.

### DETAILED DESCRIPTION

Certain terms/phrases will be explicitly defined, when and where context permits, in this Detailed Description. Such definitions are to be used for the interpretation of these terms/phrases, and their inflected forms, as used herein and in the appended claims. Furthermore, the following acronyms may appear in the description and are reproduced below for convenience:
“DEP” for data exchange package;
“FMSR” for filtered mobile subscriber record;
“MEO” for mobile exchange operator (and used synonymously with Records Exchange System);
“MNO” for mobile network operator;
“MSR” mobile subscriber record;
“RAP” for record abstraction process; and
“SRK” for secure records keeper.

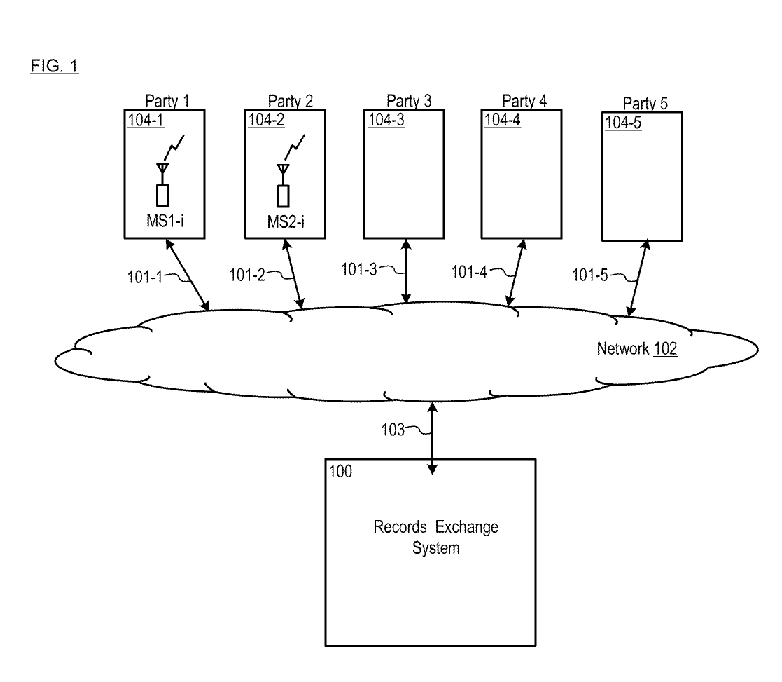

FIG. 1 depicts Records Exchange System 100, network 102, and five entities 104-1 through 104-5 that potentially utilize system 100.

In the illustrative embodiment, one or more of entities 104-1 through 104-5 are mobile network operators (“MNOs”). An MNO operates a wireless voice network and typically a wireless data network for providing wireless service to subscribers, in well known fashion. Examples of MNOs include Verizon Wireless, AT&T Mobile, and the like. In the illustrative embodiment, one or more of entities 104-1 through 104-5 is an entity other than an MNO that requires or otherwise desires access to information stored in record exchange system 100. For example, one or more of entities 104-1 through 104-5 can be a WIFI operator. One or more of entities 104-1 through 104-5 can be any type of entity involved in mobile advertising, such as, without limitation, any entity wishing to advertise, a mobile advertising network, a mobile agency, an ad publisher, and the like. Of course, in the context of its interaction with Records Exchange System 100, an MNO can be an advertiser, instead of or in addition to being a wireless service provider. In alternative embodiments, none of the entities are MNOs; rather, the entities are other types of parties, including such other types of parties mentioned above, which require or otherwise desire access to information stored in record exchange system 100.

An entity availing itself of the functionality of Records Exchange System 100 is referred to herein as a “Participating Party.” As used in this Description and the appended claims, the term “Participating Party” means:
an entity that provides information about its subscribers and/or its policy offerings to Records Exchange System 100;
an entity that receives information from Records Exchange System 100, wherein the received information pertains to:
   (i) the subscribers of one or more other entities and is typically, but not necessarily, a subset of the information that such other entities have provided to the Records Exchange System about their own subscribers; and/or
   (ii) information about the activity of its own subscribers, wherein such activity occurs when the subscriber is being serviced by one or more of the other entities using Records Exchange System 100; and/or
   (iii) information about the policies of one or more other entities using the Records Exchange System; and/or
   (iv) information concerning the implementation of the entity's own policies, as implemented by Records Exchange System 100.

Thus, in some scenarios, all Participating Parties are MNOs. In some other scenarios, the Participating Parties include one or more MNOs as well as other non-MNO entities. In some further scenarios, Records Exchange System 100 is owned or operated by an MNO and all Participating Parties are non-MNO entities.

In the embodiment depicted in FIG. 1, Participating Parties 104-1 and 104-2 are MNOs. MNO 104-1 provides service (wireless and/or data) to the mobile stations (e.g., cell phones, etc.) of a number of mobile subscribers MS1-i, i=1, p, wherein p, the number of subscribers of the network, is typically a very large number (e.g., hundreds of thousands, etc.). Likewise, MNO 104-2 provides wireless service to a large number of mobile subscribers MS2-i. Participating parties 104-3 through 104-5 are unspecified entities; as previously mentioned, they can be MNOs or non-MNO entities.

It will be understood that virtually any number of Participating Parties can utilize Records Exchange System 100; that is, fewer than the five such parties shown in FIG. 1 and, more typically, far more than five parties will use the system.

Records Exchange System 100 is a data processing system that enables information to be securely exchanged between Participating Parties, such as entities 104-1 through 104-5, who would not normally share such information. The information being exchanged between Records Exchange System 100 and the Participating Parties will typically, but not necessarily, be information pertaining to mobile subscribers (e.g., account information, device information, personal information, etc.) of one or more MNOs. The capability to exchange the personal and typically highly confidential information of a mobile subscriber with another MNO or an advertiser, for example, enables new approaches to roaming and targeted mobile advertising, and an ability to provided hosted policy services to MNOs, among any other capabilities. Further description of Records Exchange System 100, including an illustrative implementing hardware platform and the operation of the system, is provided later in this specification.

In the illustrative embodiment, Records Exchange System 100 is owned and/or operated by an Exchange operator that is independent of Participating Parties 104-1 through 104-5. In some other embodiments, at least one Participating Party will have at least a partial ownership interest or operational responsibility in Records Exchange System 100.

Network 102 is one or more data networks, such as the internet. Information, such as mobile subscriber information, is transmitted between Participating Parties 104-1 through 104-5 and Records Exchange System 100 via network 102 through respective bilateral wired or wireless telecommunications links 101-1 through 101-5, and 103.

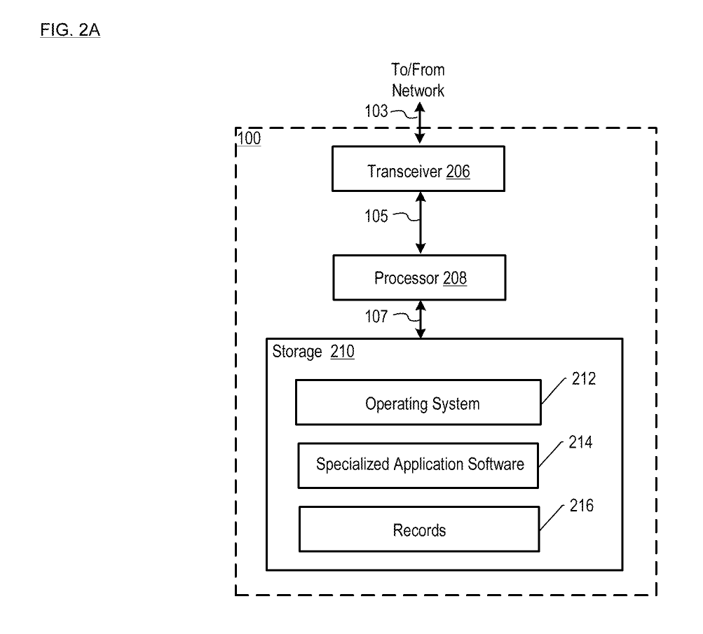

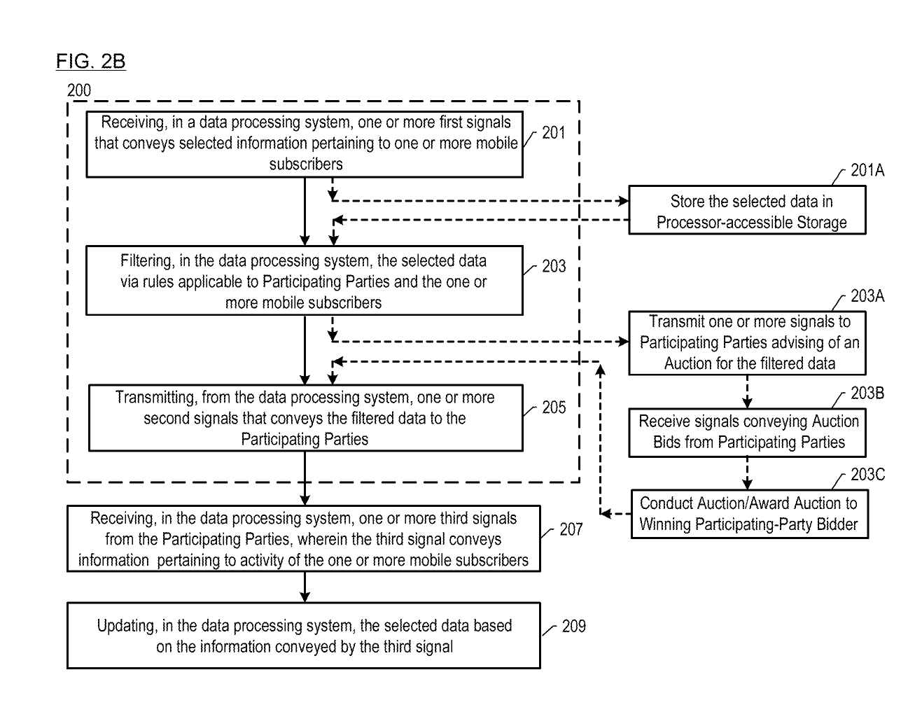

FIG. 2A depicts a block diagram of the salient components of an illustrative hardware platform for implementing Records Exchange System 100 of FIG. 1. In the embodiment depicted in FIG. 2A, Records Exchange System 100 is a data processing system comprising transceiver 206, processor 208, and processor-accessible storage 210, interrelated as shown.

In the illustrative embodiment, processor 208 is a general-purpose processor that is capable of, among other tasks, running Operating System 212, executing Specialized Application Software 214, and populating, updating, using, and managing Records 216 in processor-accessible storage 210. In some alternative embodiments of the present invention, processor 208 is a special-purpose processor. It will be clear to those skilled in the art how to make and use processor 208.

Processor-accessible storage 210 is a non-volatile, non-transitory memory technology (e.g., hard drive(s), flash drive(s), etc.) that stores Operating System 212, Specialized Application software 214, and Records 216, whether of an intermediate or archival nature. It will be clear to those skilled in the art how to make and use alternative embodiments that comprise more than one memory, or comprise subdivided segments of memory, or comprise a plurality of memory technologies that collectively store Operating System 212, Specialized Application Software 214, and Records 216.

Transceiver 206 enables Records Exchange System 100 to (i) transmit information-conveying signals to network 102 for transmission, ultimately, to the Participating Parties and (ii) to receive information-conveying signals from network 102, which are typically ultimately sourced from the Participating Parties. It will be clear to those skilled in the art, after reading this specification, how to make and use transceiver 206.

It is to be understood that FIG. 2A depicts one embodiment of a data processing system that implements Records Exchange System 100; a variety of other hardware platforms or arrangements can suitably be used. For example, system 100 can be implemented in a virtual computing environment. In some embodiments, multiple processors can be used, wherein different processors execute different Specialized Application Software programs. The use of multiple processors may be advantageous or necessary as a function of the amount of data (e.g., mobile subscriber records, etc.) being processed by Records Exchange System 100.

Furthermore, in some embodiments of system 100, the various elements depicted in FIG. 2A are co-located with one another. In some other embodiments, one or more of the elements is not co-located with the remaining elements. For example, in some embodiments, processor-accessible storage 210 is not co-located with processor 208. And as previously disclosed, processor-accessible storage 210 can be multiple separate memories, one or more of which can be physically remote from processor 208. For instance, in some embodiments, the mobile subscriber information for subscribers of a particular MNO (which in the illustrative embodiment is contained in Records 216) can be stored in a memory that is hosted at the premises of that MNO whereas other information contained in Records 216 can be stored in a memory hosted elsewhere (e.g., at the premises of the records exchange operator, etc.).

FIG. 2B depicts a flow diagram of the salient tasks in method 200 for records exchange in accordance with the illustrative embodiment of the present invention. Method 200 is supplemented by certain additional tasks, as depicted in FIG. 2B, to provide additional functionality, as discussed further below.

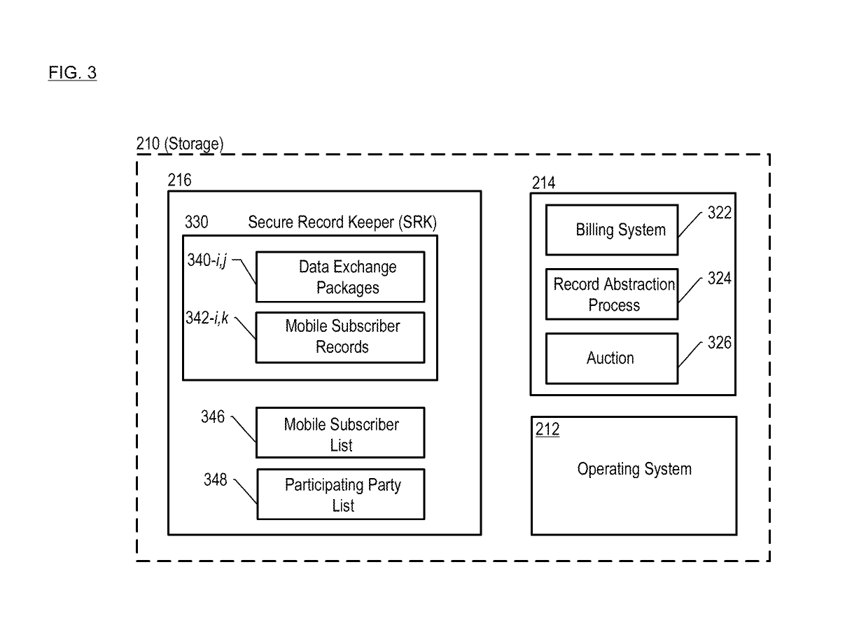

In accordance with method 200 and task 201, Records Exchange System 100 receives one or more first signals conveying selected information. The first signals are transmitted from MNOs and received by transceiver 206, as previously discussed in conjunction with FIGS. 1 and 2A. The selected information transmitted by the first signals comprises: (i) information related to one or more mobile subscribers and/or (ii) information related to rules governing interactions between an MNO and the various Participating Parties. Additional description of the selected information and the manner in which the received signals are processed is described in conjunction with FIGS. 3 through 12.

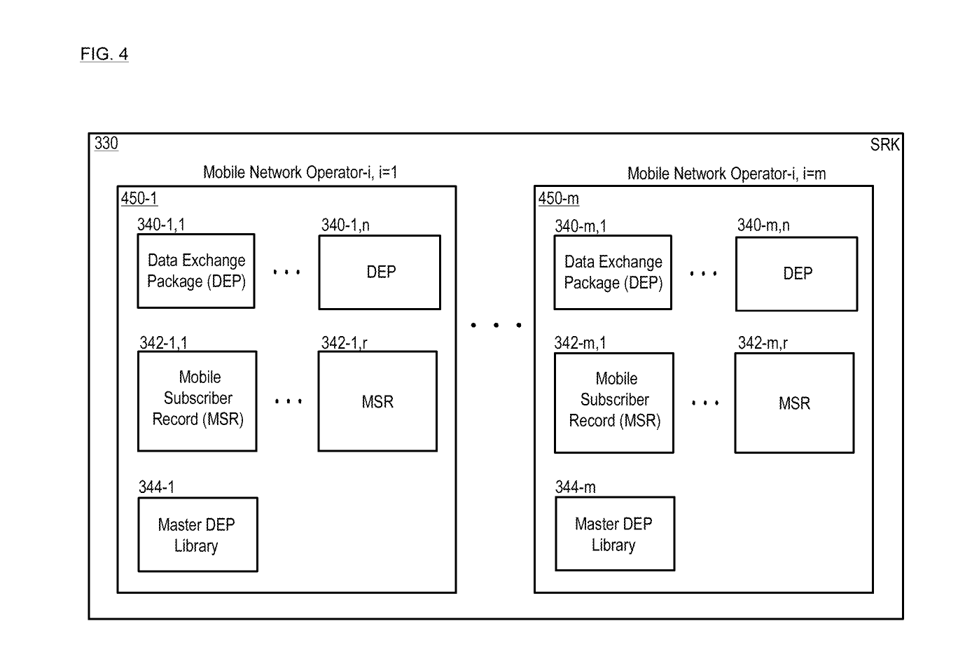

In the illustrative embodiment, task 201 includes optional sub-task 201A wherein processor 208 causes the received selected information to be stored in processor-accessible storage 210. Due to the typically highly confidential nature of at least some of selected information, its security should be assured. The secure storage of the selected data, and more detail concerning the contents of processor-accessible storage 210 (for embodiments including sub-task 201A), are discussed in conjunction with FIGS. 3 and 4. In some other embodiments (not depicted or further discussed), the selected information is transmitted directly to processor 208 for processing and is not archived in processor-accessible storage 210. Although considered to be optional, sub-task 201A is advantageous and is performed in preferred embodiments of the method.

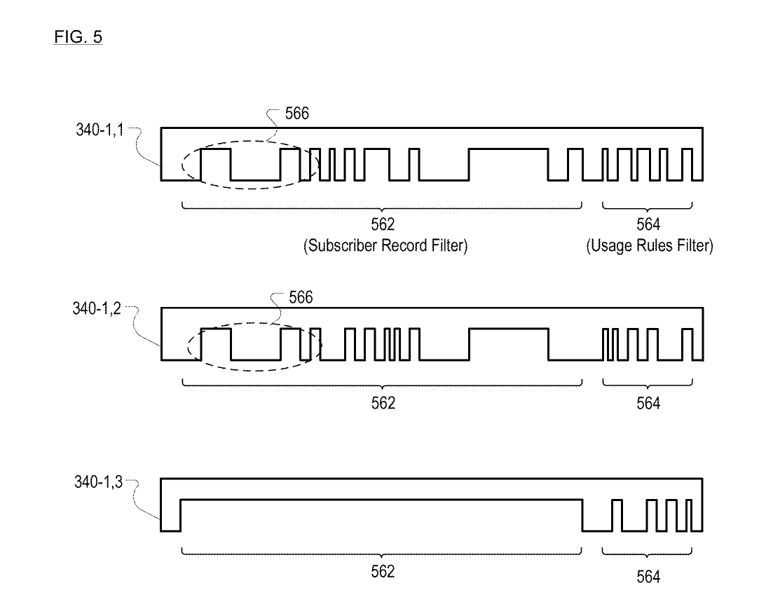

In accordance with task 203, the selected data pertaining to the mobile subscribers is filtered in accordance with the rules, as embodied in “data exchange packages,” governing the interactions between the subscriber's home MNO, the mobile subscribers, and Participating Parties. Task 203 is discussed in more detail in conjunction with FIGS. 5 through 7.

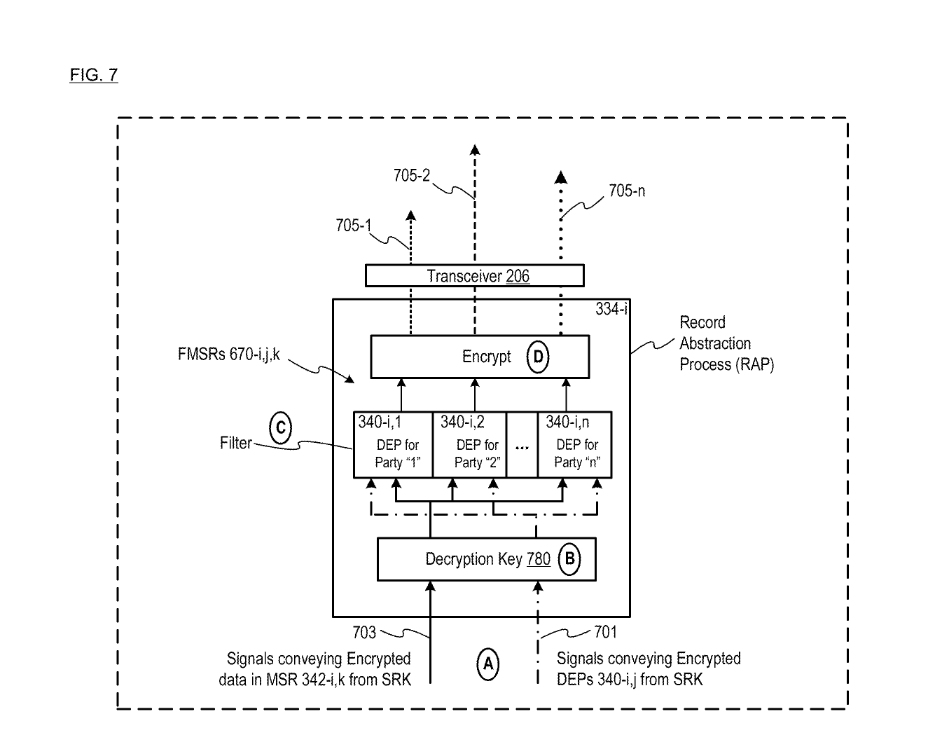

In accordance with task 205, the filtered mobile subscriber data is conveyed, via one or more second signals transmitted from Records Exchange System 100, to appropriate Participating Parties. This task is discussed in further detail in conjunction with FIG. 7 and elsewhere in this Detailed Description.

Additional functionality is provided in conjunction with the performance of tasks 207 and 209. These tasks expand method 200 to enable archived mobile subscriber records to be updated. At task 207, the data processing receives one or more third signals that convey, for example and without limitation, updated subscriber activity (usage data, etc.) from a Participating Party. This is occasioned, for example, when a mobile subscriber “roams” to the Participating Party (i.e., a Participating Party that is an MNO) from its home MNO. It is desirable to update the archival records (i.e., mobile subscriber records in Records Exchange System 100) to reflect the subscriber's activity while roaming.

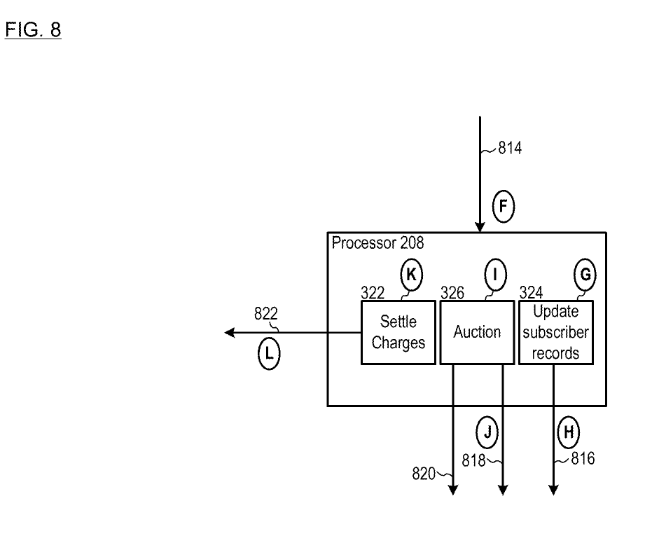

At task 209, Records Exchange System 100 updates its archived mobile subscriber records and/or transmits a signal conveying the updated subscriber records, in an appropriate format, to the home MNO. The functionality provided at tasks 207 and 209 is described in further detail in conjunction with FIG. 8.

Still further functionality is provided with the performance of supplemental tasks 203A through 203C, wherein Records Exchange System 100 conducts an auction for filtered mobile subscriber information. In accordance with task 203C, Records Exchange System 100 transmits a signal to Participating Parties advising that an auction for mobile subscriber records is to be conducted. A Participating Party wishing to access the filtered records submits a bid to Records Exchange System 100 in hopes of winning the auction. The Participating Party might, for example, use the filtered records to improve the hit rate of a mobile advertising campaign, such as by serving ads to subscribers that, based on the information contained in their filtered record, are more likely than the general public to be interested in the advertised product or service. Thus, at task 203B, Records Exchange System 100 receives signals conveying auction bids. At task 203C, System 100 conducts the auction and awards the auction to the highest bidder. The filtered data is then conveyed, via the one or more second signals, to the Participating Party that won the auction (e.g., task 205).

FIG. 3 depicts, for the illustrative embodiment, further detail about the contents of processor-accessible storage 210. As depicted in FIG. 3, Records 216 includes:
Data Exchange Packages 340-i,j;
Mobile Subscriber Records 342-i,k;
Mobile Subscriber Opt-in List 346;
Participating Party List 348.

In accordance with the illustrative embodiment, a party wishing to avail itself of the services provided by Records Exchange System 100 “opts-in” to the system (thereby becoming a Participating Party). If the party is an MNO, the opt-in process includes, in the illustrative embodiment, executing individual bi-lateral records exchange agreements between the MNO and all other MNOs participating in record exchange system 100. The bi-lateral agreements control, among other issues, the amount/type of mobile-subscriber information that the NMOs will share with one another. If the party is an entity other than an MNO, the record exchange agreement with participating MNOs will, of course, be more unilateral in nature (since the non-NMO party will not generally have its own subscribers with records to protect). Record exchange agreements are not typically established between two non-NMO parties. In some embodiments, a list—Participating Party List 348—provides the identity of all parties that have opted-in to Records Exchange System 100. This identifier can be used to reference a specific Participating Party within Records 216.

As a consequence of strict confidentiality/privacy concerns and, in some cases, privacy laws, individual mobile subscribers “opt-in” to Records Exchange System 100 in the illustrative embodiment. In other words, in the illustrative embodiment, even though a subscriber's home MNO has opted-in to System 100, each mobile subscriber independently “opts-in,” thereby explicitly providing permission to the home MNO and Records Exchange System 100 to share the subscriber's confidential records with, for example, other Participating Parties. In some other embodiments, an explicit opt-in is not performed (e.g., permission can be obtained outside the context of Records Exchange System 100, or permission can be implicit in view of participation by the mobile subscriber in other services the home MNO provides, etc.). In some embodiments, Mobile Subscriber list 346 “identifies” all mobile subscribers that opt-in to Records Exchange System 100. In some embodiments, List 346 will not explicitly reference the identity (i.e., the name) of the mobile subscriber. Rather, for example, List 346 includes the International Mobile Subscriber Identity (“IMSI”), Temporary Mobile Subscriber Identity (“TMSI”), or the like, or, alternatively, “de-identification technologies” can be used to protect the actual identity of any particular mobile subscriber.

As depicted in FIG. 3, at least some of the information contained in Records 216 is maintained within Secure Record Keeper (“SRK”) 330. In some embodiments, each participating MNO has its own SRK; in some other embodiments, each MNO has storage location allocated to it within a single “universal” SRK.

However conceptualized or implemented, SRK 330 is a secure region of processor-accessible storage 210. Security can be assured via any one or more of a number of means. For example, a dedicated link (or links) can be used (e.g., layer 1 physical or layer 2/3 virtual dedication) and/or L3 encryption, such as IPsec, can be used. In the illustrative embodiments, the SRK is further secured through data storage encryption, wherein each MNO holds the decryption key for its SRK (or portion thereof). In some other embodiments, data storage encryption can be used as an alternative to other types of security. In the illustrative embodiment, the decryption key is maintained by each MNO at the premises thereof. In further embodiments, the MNOs can store their decryption key within SRK 330. In some embodiments, the stored data is encrypted such that MNOs can prevent any other party from accessing its stored information.

In the illustrative embodiment, the information stored in SRK 330 includes Data Exchange Packages (“DEPs”) 340-i,j and Mobile Subscriber Records (“MSRs”) 342-i,k. In some other embodiments, Mobile Subscriber List 346 is located within SRK 330. In some of such embodiments, each MNO maintains its own list of opted-in mobile subscribers; in some other of such embodiments, a single list of all opt-in mobile subscribers, irrespective of the home network thereof, is maintained in SRK 330. The information contained in DEPs 340-i,j and MSRs 342-i,k is discussed more fully below in conjunction with FIG. 4.

It is to be understood that terms such as “list,” “record,” “package,” etc., are used as a linguistic convenience and are not intended to specify or otherwise limit the manner in which the referenced information is stored or organized. For example, the use of such terms is not intended to require any particular data structure for the stored data. Also, reference to multiple (independent) lists—such as one for opted-in mobile subscribers and another for the Participating Parties—is not intended to mandate the use of multiple lists; a single list can be used, for example, for storing both Participating Parties and mobile subscribers. Indeed, one skilled in the art will understand that the information contained in processor-accessible storage 210 can be organized in any convenient manner.

Processor-accessible storage 210 also contains Specialized Application Software 214, which includes, among other software, Billing System 322 and Record Abstraction Process 324.

Billing System 322 comprises processor-executable instructions for apportioning, as appropriate, charges/fees between the various entities using the system (e.g., Parties 104-1 through 104-5, etc.), as well as for retaining a portion of the charges or fee for Records Exchange System 100. In some embodiments, Billing System 322 accesses information contained in SRK 330 to apportion charges/fees.

Billing System 322 is used, for example, to apportion the fees paid by the mobile subscriber in embodiments in which Records Exchange System 100 facilitates mobile broadband “roaming.” Since both the home network and the visited network(s) provide service for some portion of the subscriber's pay period, it is appropriate to apportion the fees paid by the mobile subscriber between such networks. Embodiments of Billing System 322 are also used for scenarios in which Records Exchange System 100 supports mobile advertising. For example, Billing System 322 can be used implement financial incentives to the mobile subscribers and to apportion advertising fees between, for example, the home network and the Records Exchange System 100 and/or other parties. After reading this specification, those skilled in the art will be able to implement Billing System 322 for use in conjunction with Records Exchange System 100.

Record Abstraction Process (“RAP”) 324 comprises processor-executable instructions that generate “filtered” mobile subscriber records. The filtering is based on the records exchange agreement, as embodied in the Data Exchange Packages, between the home network (for the particular mobile subscriber) and the particular Participating Party that will be receiving the filtered mobile subscriber record. More particularly, DEPs 340-i,j are used to filter the information pertaining to any given mobile subscriber, as contained in Mobile Subscriber Records (“MSR”) 342-i,k. The filtered information is typically a sub-set of the information contained in MSR 342-i,k. DEPs 340-i,j are discussed in more detail in conjunction with FIGS. 4 through 6 and RAP 324 is discussed in more detail in conjunction with FIG. 7.

FIG. 4 depicts further detail of an illustrative embodiment of SRK 330. In the embodiment depicted in FIG. 4, the SRK comprises a plurality of storage blocks 450-i, each of which storage blocks contain:
a plurality of Data Exchange Packages 340-i,j wherein j=1,n
a plurality of Mobile Subscriber Records 342-i,k wherein k=1,r
Master Data Exchange Package Library 344-i.
   In this embodiment, each MNO-i has its own region of secure storage 450-i wherein i=1,m within SRK 330. The variable “i” is an identifier for the MNO (e.g., MNO-1, MNO-2, etc.). The variable “m” is the number of MNOs that have opted-in to Records Exchange System 100.

The data within a given storage block 450-i pertains to mobile subscribers of the associated MNO-i. Thus, from the perspective of those mobile subscribers, the associated NMO-i is the “home” MNO. For example, for storage block 450-1, the associated MNO is MNO-1 and the data in MSRs 342-1,k pertains to subscribers of MNO-1.

The information in MSRs 342-i,k is sourced from the home MNO of those subscribers. In accordance with the illustrative embodiment, under appropriate conditions (e.g., mobile subscriber opt-in, if necessary, etc.), subscriber information is transmitted from the home MNO to Records Exchange System 100. The information that is transmitted is typically a subset of all information available about a mobile subscriber, such as is available in the HLR/HSS of the MNO. As used in this Description and the appended claims, the term “selected mobile subscriber data” means a portion—that is, some but not all—of the information in the possession of the home MNO pertaining to a given mobile subscriber. The home MNO and/or each mobile subscriber and/or applicable law determines what types of information are acceptable to forward to Records Exchange System 100. As such, in the illustrative embodiment, the mobile subscriber record 342-i,k comprises selected mobile subscriber data from the HLR/HSS and other records of the home MNO.

In the illustrative embodiment, each MNO-i has, in its SRK storage 450-i, MSRs for a number “r” of opt-in subscribers. In some other embodiments, MSRs are created for all mobile subscribers of the MNO, whether or not they opt-in. In such embodiments, if a mobile subscriber does not “opt-in,” then the MSR that contains the subscriber's information will not be accessed by RAP 324.

As noted above, an MNO's block of storage 450-i contains a plurality of DEPs 340-i,j wherein j=1,n. The variable “i” is an identifier for the associated MNO and “j” is an identifier for the Participating Party. As previously mentioned, in some embodiments, the identifier “j” is stored in Participating Party List 348. The variable “n” is the number of Participating Parties that have executed record exchange agreements with a particular NMO-i. It is likely that at least some Participating Parties will not establish a data-exchange relationship with every other Participating Party of Records Exchange System 100. As such, there may be a different number of DEPs 340-i,j within storage 450-i for different MNOs. In other words, the number “n” can vary from MNO to MNO.

As previously, indicated, the Data Exchange Packages or “DEPs” are rules packages that, in the illustrative embodiment, arise from the records exchange agreement executed between the home network and each Participating Party with which the home MNO is willing to share subscriber information. As previously noted, in some alternative embodiments, records exchange “agreements” can arise by default.

As used in this Description and the appended claims, the term “Data Exchange Package” or “DEP” means:
(i) a set of rules, parameters, and/or guidelines that control what particular information the home network divulges to a Participating Party about a mobile subscribers of the home network; and optionally
(ii) a set of rules, parameters, and/or guidelines that control subscriber non-specific interactions between the home network and the Participating Party(ies).
   As explained further below, these rules, parameters, and/or guidelines can be in the form of memory addresses (e.g., in a subscriber's MSR, etc.) at which information that is to be “exchanged” (i.e., forwarded to a Participating Party) can be found. As to item (i), the determination of what information is acceptable to divulge is determined by at least one of the following: the home network, the mobile subscriber, and applicable laws.

More particularly, and as discussed in further detail later in this specification, in conjunction with the Record Abstraction Process 324, the DEP “filters” information about a particular mobile subscriber, a class of mobile subscribers, or all opted-in mobile subscribers of a particular network. As such, in some embodiments, a given storage block 450-i of an MNO-i within SRK 330 might contain, for each Participating Party: (i) a different DEP for each mobile subscriber, (ii) different DEPs for different classes of subscribers (e.g., for subscribers age 12 and under, for subscribers age 13-17, and for subscribers age 18 or older, etc.), or (iii) a single DEP for all opt-in mobile subscribers of the home network. And, as indicated, a particular DEP can apply to (i) a single Participating Party, (ii) a class of Participating Parties (e.g., all “third party” MNOs, etc.), or (iii) all Participating Parties.

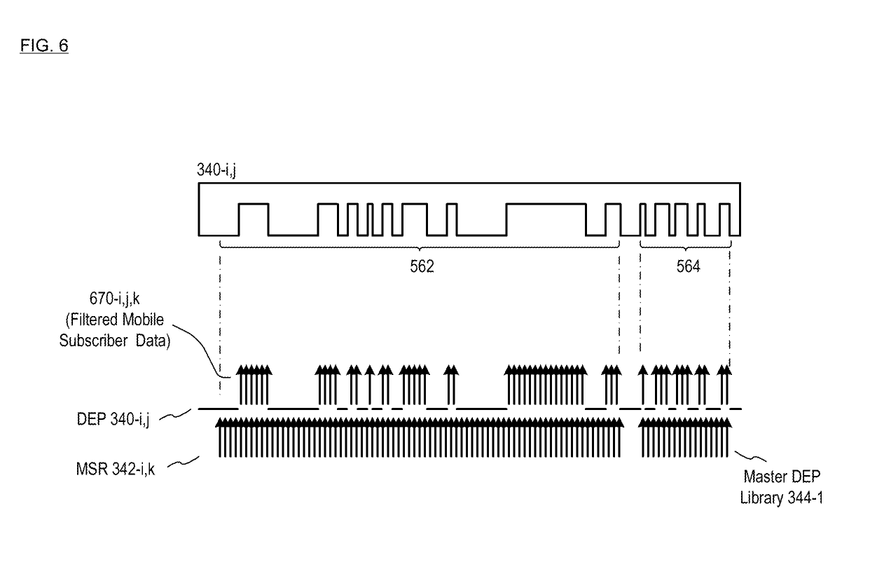

For pedagogical purposes, DEP 340-i,j can be conceptualized as a “comb” filter, the structure and operation of which, in the present context, is figuratively illustrated in FIGS. 5 and 6. FIG. 5 depicts three such conceptual DEPs 340-1,1; 340-1,2; and 340-1,3. In the illustrative embodiment, each DEP has portion 562 that “filters” the mobile subscriber record (per the first part of the definition of “DEP”) and portion 564 that filters a master set of usage rules established by the home MNO (per the second optional part of the definition of “DEP”).

FIG. 6 provides a conceptual illustration of the “filtering” operation using DEP 340-i,j and MSR 342-i,k. As depicted in FIG. 6, the subscriber information contained within MSR 342-i,k (i.e., all data pertaining to mobile subscriber “k” of MNO-i that the MNO has provided) is presented to a filter, as embodied by DEP 340-i,j. This filtering operation, which occurs during the execution of RAP 324, produces filtered mobile subscriber record (“FMSR”) 670-i,j,k. This record includes the information about subscriber MSi-k that is to be sent to Participating Party j. It is apparent that, at least for the example in FIG. 6, FMSR 670-i,j,k contains a sub-set of the subscriber information for subscriber k contained in MSR 342-i,k. As used in this Description and the appended claims, the term “Filtered Mobile Subscriber Record” means a record generated from the selected mobile subscriber records by “filtering” it, as that term is used herein, via a DEP.

Referring again to FIG. 5, there can be, and will typically be, structural similarities between different DEPs. For example, portion 566 of DEP 340-1,1 and DEP 340-1,2 are identical. The significance of this is that the home MNO is willing to share some of the same type of information about subscribers with different Participating Parties. Continuing with the comb-filter metaphor, this means that portion 566 of these DEP “filters” would permit the same information to “pass” the filter. Thus, the filtered information destined for Participating Parties j=1 and j=2 would include at least some of the same information about a particular mobile subscriber. If the filters are, instead, applied to two or more different mobile subscribers of a particular MNO, then the resulting filtered information destined for the Participating Parties j=1 and j=2 would include the same type of information (e.g., the amount of data they can use over a certain period of time, etc.) for all such mobile subscribers.

With continuing reference to FIG. 5, the structure of DEP 340-1,3 permits the full subscriber record presented to it (i.e., MSR 342-1,k) to pass. This indicates that the home MNO (i.e., MNO-1 in this example) is willing to permit Participating Party j=3 to view all information that the MNO-1 has placed in MSR 342-1,k within its storage block 450-1.

It will be understood that the DEP does not actually filter the data in the manner shown; this is a metaphor. As previously disclosed, in some embodiments, the DEP provides the storage locations for information from mobile subscriber records 342-i,k that are to be copied into record FMSR 670-i,j,k destined for Participating Party j. These or other arrangements for implementing DEPs, as will occur to those skilled in the art after reading this specification, may suitably be used.

As illustrated in FIG. 5, portion 564 of DEPs 340-1,1; 340-1,2; and 340-1,3 functions as a “filter” for usage rules. These usage rules involve, for example, certain policies that the (home) MNO wishes to apply to a Participating Party. For example, assuming that a given Participating Party is another MNO, portion 562 might extract information from an MSR 342-i,k such as how much data a particular mobile subscriber is permitted to use in a given period of time. In contrast, portion 564 might extract information that dictates, for example, certain actions that the visited MNO must take (or cannot take) with respect to all subscribers from the particular home network that roam into that particular MNO or certain information that the visited MNO must provide to the home MNO. In such an embodiment, the home MNO establishes master DEP library 344-i in its storage block 450-i within SRK 330. After reading this specification, those skilled in the art will be able to implement alternative embodiments in which a master DEP is not employed and usage rules applicable for a Participating Party are obtained in a different manner.

It will be appreciated that although the DEPs are, in the illustrative embodiment, based on information exchange agreements reached between a (home) MNO and various Participating Parties, it is advantageous for Records Exchange System 100 to actually create the DEPs using the information contained in the agreements. This is appropriate since to “filter” a mobile subscriber record, the DEPs and RAP 324 must have requisite information concerning the precise storage locations of particular types of information within the subscriber's MSR as well as other detailed processing information.

FIG. 7 depicts an embodiment of Record Abstraction Process 324 wherein filtered mobile subscriber records are generated. As previously disclosed, RAP 324 is a specialized software application, executed by processor 208 (FIG. 2), for use in conjunction with Records Exchange System 100.

FIG. 7 depicts tasks A through D being performed by RAP 324 for a particular MNO-i. In that regard, there is a discrete instantiation of the RAP for each MNO-i.

In accordance with task A, the RAP causes appropriate DEPs 340-i,j, as stored in the MNO's storage block 450-i in SRK 330, to be copied (into registers that are available) to processor 208. Signals 701 convey the copied DEPs from processor-accessible storage 210 to processor 208. In some embodiments, the DEPs are encrypted. In such embodiments, the DEPs are decrypted via the MNO's decryption key 780, as per task B. RAP 324 also causes a copy of appropriate mobile subscriber records 342-i,k, as stored in the MNO's storage block in SRK 330, to be transmitted to processor 208. Signals 703 convey the copied MSRs 342-i,k from processor-accessible storage 210 to processor 208. In the illustrative embodiment, the MSRs are encrypted, so, at task B, the MSRs are decrypted via the MNO's decryption key 780.

At task C, MSRs 342-i,k are filtered by DEPs 340-i,j, as previously discussed, to generate filtered mobile subscriber records (“FMSR”) 670-i,j,k. In the illustrative embodiment, the MSR is shown being filtered in parallel by DEPs of each Participating Party with which the home MNO has an agreement. It is possible that some, but not all, of those Participating Parties are to receive an FMSR of a particular subscriber. For such a scenario, in some embodiments, RAP 324 operates so that the subscriber's MSR is filtered by only those DEPs applicable to the Participating Parties that will be receiving the subscriber's FMSR. For the same scenario, in some other embodiments, the subscriber's MSR is filtered by all DEPs for all Participating Parties (even though some of the Parties will not receive the FMSR).

In accordance with the illustrative embodiment, at task D, FMSRs 670-i,j,k are encrypted. The encryption can be the same as applied to the records kept in the MNO's storage block 450-i. Alternatively, a different encryption scheme implemented by Records Exchange System 100 can be applied at task D.

Transceiver 206 transmits signals 705 (e.g., 705-1, 705-2, . . . 705-n) to the appropriate Participating Parties, thereby conveying filtered mobile subscriber records 670-i,j,k thereto.

It is to be understood that the order of tasks A through D is permutable and, furthermore, not all tasks are required in all embodiments. For example, in some embodiments, task C (filtering) occurs before task A (copying). In such embodiments, the DEPs operate on MSRs 342-i,k within the SRK; that is, only the information that will ultimately be transmitted to the Participating Parties is accessed by RAP 324. In these embodiments, tasks B and D may not be necessary. Furthermore, in scenarios in which encryption is considered unnecessary, task D is optional. In light of this disclosure, those skilled in the art will be able to make and use RAP 324 and the DEPs.

In addition to providing the functionality discussed thus far, Records Exchange System 100 is capable, in some embodiments, of providing the functionality implemented at tasks F through L depicted in FIG. 8.

In particular, the Records Exchange System is capable of receiving signals 814 (task F), which convey information from Participating Parties. Such information can include, without limitation, the activity of a mobile subscriber in a visited network (i.e., other than the home MNO) or, for example, auction bids for the information contained in Filtered mobile subscriber record 670-i,j,k. Based on the information received via signals 814, processor 208 is capable of updating MSRs 342-i,k (task G). The updating process is performed in conjunction with RAP 324.

In some embodiments, the updating process is performed “directly” via RAP 324, wherein, after appropriate processing (e.g., decryption, encryption, mapping, etc.) signals that convey updated mobile subscriber information are transmitted to processor-accessible storage 210 to update the MSRs. In such embodiments, RAP 324, in conjunction with transceiver 206, also transmits signal 816 conveying updated mobile subscriber information to the subscriber's home MNO, in accordance with task H.

In some other embodiments, the updating process is performed “indirectly.” In such embodiments, RAP 324 provides appropriate processing (e.g., decryption, encryption, mapping, etc.) of the received information. Then, in conjunction with transceiver 206, RAP 324 transmits signal 816, which conveys the updated mobile subscriber information to the home MNO per task H. Once received, the MNOs records can be updated. Selected records, which include at least some updated records, are then transmitted to Records Exchange System 100 for updating MSRs 342-i,k in the MNOs block 450-i of secure storage in the SRK.

If the information conveyed by signal 814 from a Participating Party to Records Exchange System 100 pertains, for example, to an auction bid for filtered mobile subscriber records 670-i,j,k, other Specialized Application Software 214, such as “Auction” software 326 for conducting an auction, is used in some embodiments to process the received auction bid at task I and ultimately award the auction to the Participating Party that submits the best bid. Auction software 326, in conjunction with transceiver 206, transmits signal(s) 818 to the winning Participating Party advising the Party of its win, per task J. Depending upon application specifics, additional signals 820 conveying other information are sent to other parties in conjunction with the auction win.

The information conveyed by signal 814 from a Participating Party to Records Exchange System 100 might indicate that it is appropriate to apportion or settle charges, such as when a roaming mobile subscriber returns to the home MNO. Billing System 322 provides that functionality at task K. In conjunction with transceiver 206, Billing System 322 transmits, at task L, signal 822 conveying information pertaining to the settled charges to the appropriate Participating Parties.

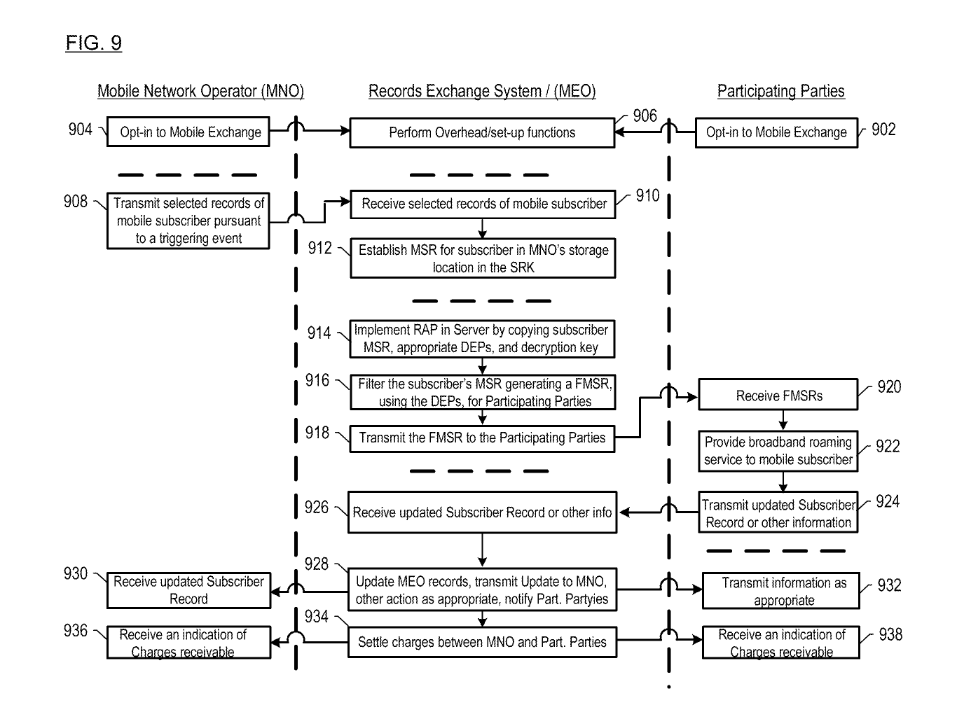

FIGS. 9 through 12 depict an example of Records Exchange System 100 in use.

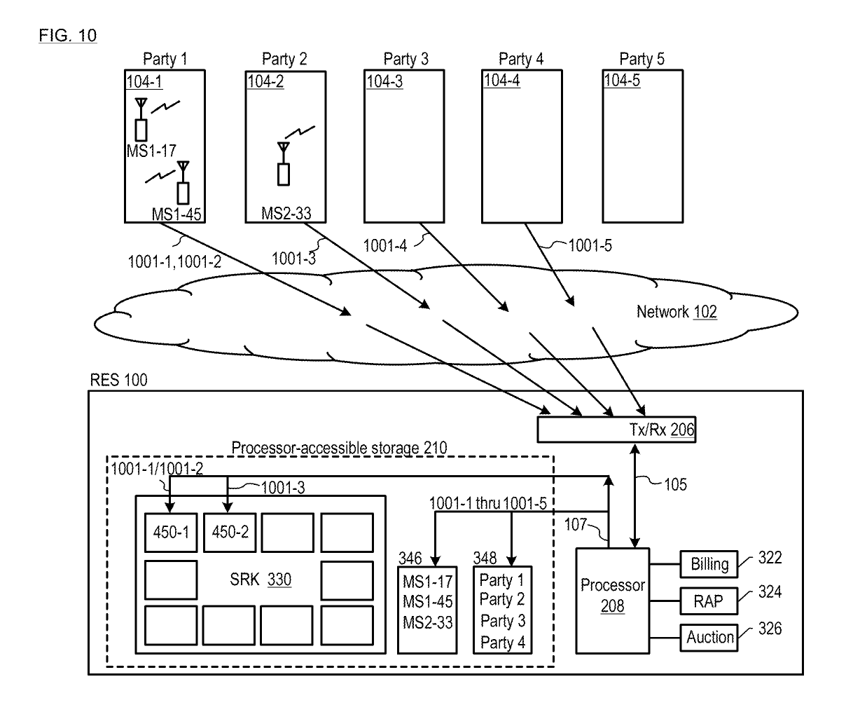

Referring now to FIG. 10, Parties 104-1, 104-2, 104-3, and 104-4 have opted-in to System 100 to become Participating Parties. Parties 104-1 and 104-2 are both MNOs and parties 104-3 and 104-4 are advertisers (but not MNOs). For this example, the subscriber record that is being filtered is associated with a subscriber of Party 104-1. As a consequence, Party 104-1 is, for the purposes of this example, the home MNO. Party 104-5 does not opt-in and is therefore not a Participating Party.

FIG. 9 depicts, via a flow chart, the tasks being performed at/by: Party 104-1, Records Exchange System/MEO 100, and Participating Parties other than Party 104-1. At task 902, the Participating Parties other than Party 104-1 opt-in. At task 904, Party 104-1 opts-in. Information required at opt-in is conveyed by signals 1001-1 through 1001-5.

Certain tasks occur as part of the opt-in process (task 904). In some embodiments, a party wishing to opt-in, in particular an MNO, performs at least some of the following tasks:
Contact the MEO to express interest in opting-in.
Receive information from the MEO as to the identity of currently Participating Parties.
Establish records exchange agreements with Participating Parties of interest.
Work with the MEO to develop DEPs for use in filtering mobile subscriber records.

In some embodiments, Records Exchange System 100 performs certain overhead tasks 906 as part of the opt-in procedure, including, without limitation:
Establish secure records storage for the MNO.
Store the DEPs in the MNO's secure storage.

At task 908, selected mobile subscriber records of one or more mobile subscribers are transmitted from Party 104-1 to Records Exchange System 100. In this example, the records for subscribers MS1-17 and MS1-45 are transmitted via signals 1001-1 and 1001-2. Since Party 104-2 is also an MNO, it also transmits records to System 100; signal(s) 1001-3 conveys the records for subscriber MS2-33.

The home MNO transmits its records in response to a triggering event. The triggering event can be, for example, mobile subscriber MS1-17 announcing to the home MNO (i.e., party 104-1) the desire to opt-in. In some alternative embodiments, the transmission of records does not occur upon subscriber opt-in. Rather, records are transmitted in response to a need for them. In accordance with the present teachings, a need for the subscriber records arises, for example, when an opt-in mobile subscriber roams from the home MNO to another Participating Party that is an MNO. In such embodiments, the triggering event is notification received by the home MNO that the mobile subscriber intends to (or has) roamed to another MNO. Such notification can be received from the subscriber, the visited MNO, or Records Exchange System 100.

In some other embodiments, selected records of all mobile subscribers of an MNO are transmitted as part of the MNO's opt-in. In such an embodiment, the records are not accessed for filtering, etc., unless and until there is express opt-in by each mobile subscriber.

In the example, Records Exchange System 100 receives the selected records of subscribers MS1-17, MS1-45, and MS2-33 as per task 910. System 100 establishes Mobile Subscriber Records (i.e., MSR-i,k) for each subscriber within the secure storage of the appropriate MNO at task 912. That is, MSRs 342-1,17 and 342-1,45 are established in block 450-1 of SRK 330 (see, e.g., FIG. 4). This corresponds to task 201A of method 200 (FIG. 2B). This task is depicted in FIG. 10 wherein signals 1001-1 and 1001-2 are transmitted over communications link 107, via processor 208, to storage block 450-1 in SRK 330 to establish the MSRs. Likewise, signal(s) 1001-3 conveying the records of subscriber MS2-33, is transmitted to storage block 450-2 in SRK 330 to establish an MSR for that subscriber.

FIG. 10 also depicts Participating Party list 348 being populated with an identifier for each of the Participating Parties; namely, 104-1, 104-2, 104-3, and 104-4. Mobile Subscriber list 346 is populated with an identifier for each subscriber that has opted-in; namely, MS1-17, MS1-45, and MS2-33.

Referring again to FIG. 9, at task 914, Records Exchange System 100 establishes RAP 924 in processor 208, wherein mobile subscriber records, DEPs, and as applicable, a decryption key are copied into the RAP (see, e.g., FIG. 7). At task 916, and as previously described, the mobile subscriber records are “filtered” via DEPs to generated filtered mobile subscriber records (i.e., FMSR 670-i,j,k). As appropriate, the filtered records are encrypted for transmission, and, at task 918, the records are transmitted to the appropriate Participating Parties.

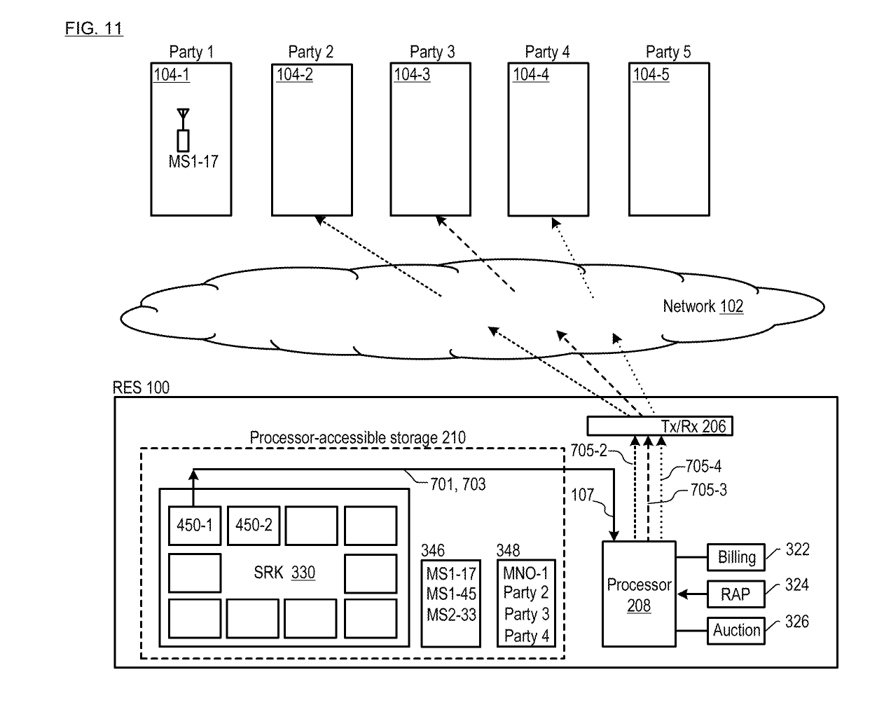

Tasks 914 through 918 are illustrated in FIG. 11, wherein a copy of the MSR for subscriber MS1-17 and a copy of the appropriate DEPs from storage block 450-1 in SRK 330 are transmitted, via signals 701 and 703, to the processor. The signals are sent, for example, over communications link 107. In the instantiation of the RAP for Participating Party 104-1, subscriber records MSR 342-1,17 are filtered (after decryption in some embodiments). The filtered records FMSR 670-1,2,17; 670-1,3,17; and 670-1,4,17 are then transmitted by transceiver 206 (after encryption in some embodiments) via signals 705-2, 705-3, and 705-4 over network 102 to respective Participating Parties 104-2, 104-3, and 104-4. In some alternative embodiments, FMSRs are only sent to Participating Parties that have a need for them or explicitly expressed interest. For example, if Records Exchange System 100 is being used to support mobile broadband roaming, then in some embodiments, an FMSR corresponding to a particular mobile user (e.g., MS1-17, etc.) is sent to only those Participating Parties that are visited by that mobile user.

With continuing reference to FIG. 9, the signals conveying the filtered mobile subscriber record are received by the appropriate Participating Parties, as per task 920.

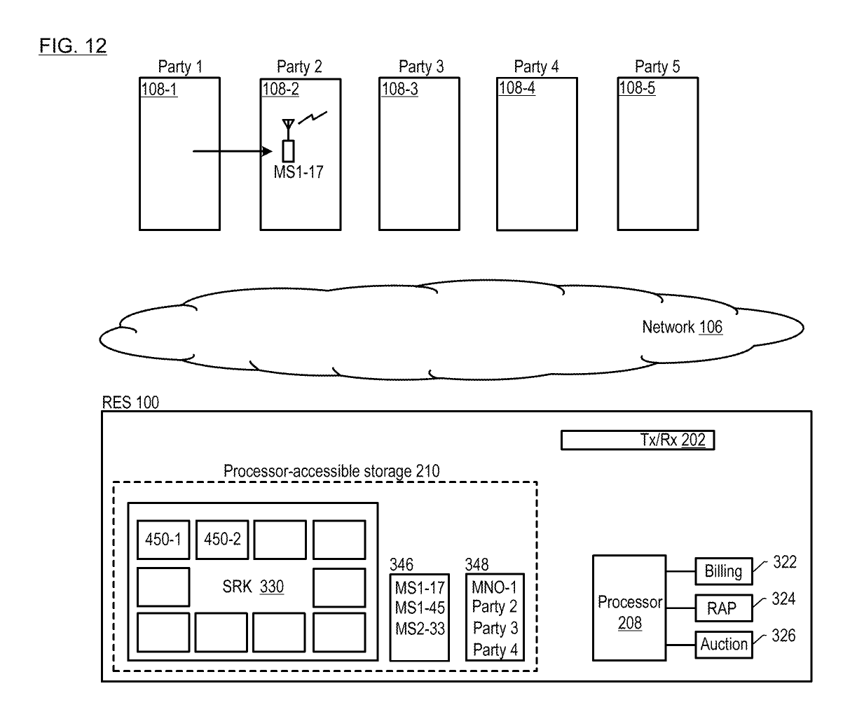

In this example, as depicted in FIG. 12, subscriber MS1-17 roams to Participating Party 104-2 (also an MNO). As per task 922 of FIG. 9, the visited Participating Party provides broadband roaming service to mobile subscriber MS1-17 in accordance with the information provided in the filtered mobile subscriber record. After roaming for a period of time, the subscriber leaves Party 104-2 and returns to the home network (i.e., Party 104-1).

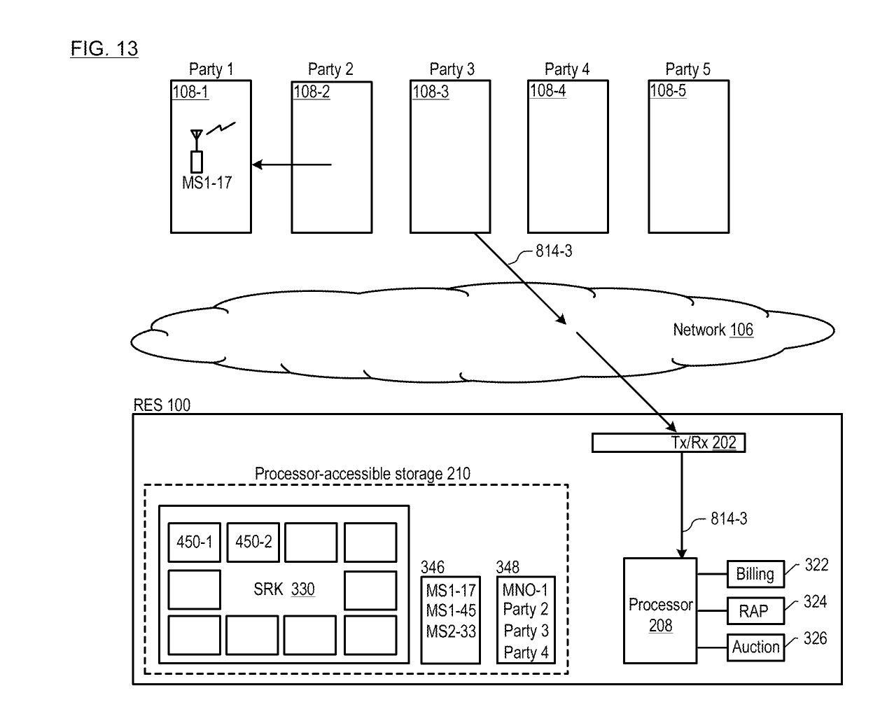

After subscriber MS1-17 leaves the visited network (i.e., Participating Party 104-2), the visited network transmits a summary of the subscriber's activity within the visited network, as per task 924. This is depicted in FIG. 13, wherein Party 104-2 transmits the subscriber activity to Records Exchange System 100 via signal(s) 814-3 (see also FIG. 8). FIG. 13 also depicts System 100 receiving signal(s) 814, per task 926 of FIG. 9.

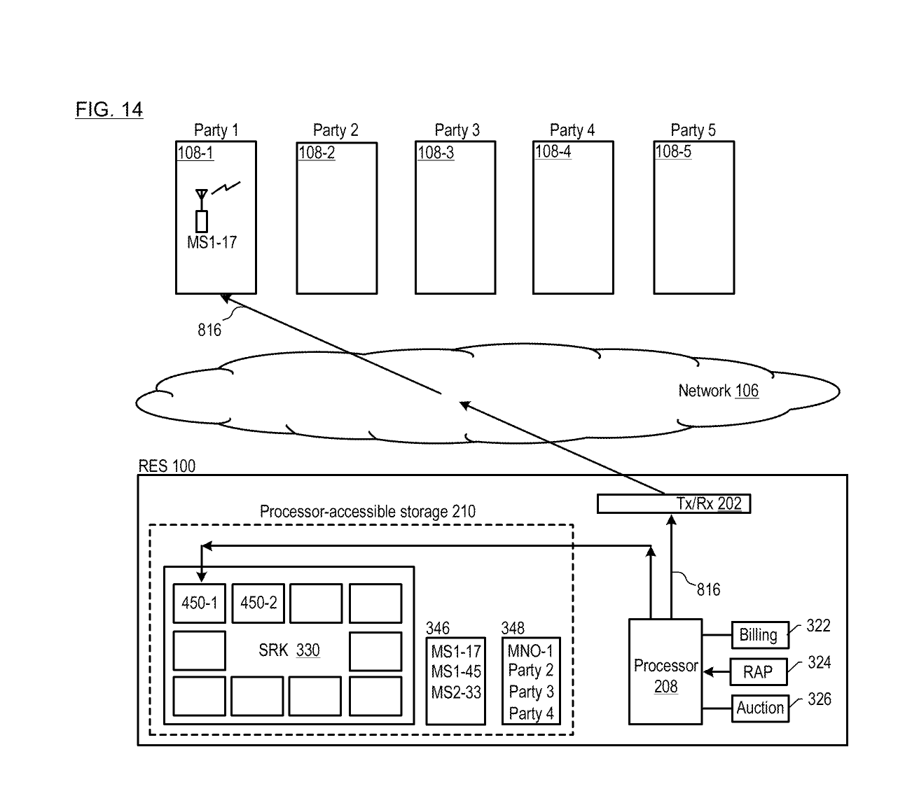

In accordance with task 928 of FIG. 9, and as depicted in FIG. 14, Records Exchange System 100 updates the records of subscriber MS1-17, such as via an instantiation of RAP 324. As previously discussed, updating can be a captive process, wherein the RAP directly updates the archival records with SRK 330. Alternatively, the records can be updated by first sending updated subscriber activity to the home network, which then updates its records and transmits the updated records to System 100 to re-populate the archival records with SRK 330. In either case, Records Exchange System 100 transmits signal(s) 816, which convey the updated records to the home MNO (i.e., Party 104-1), as per task 930 of FIG. 9.

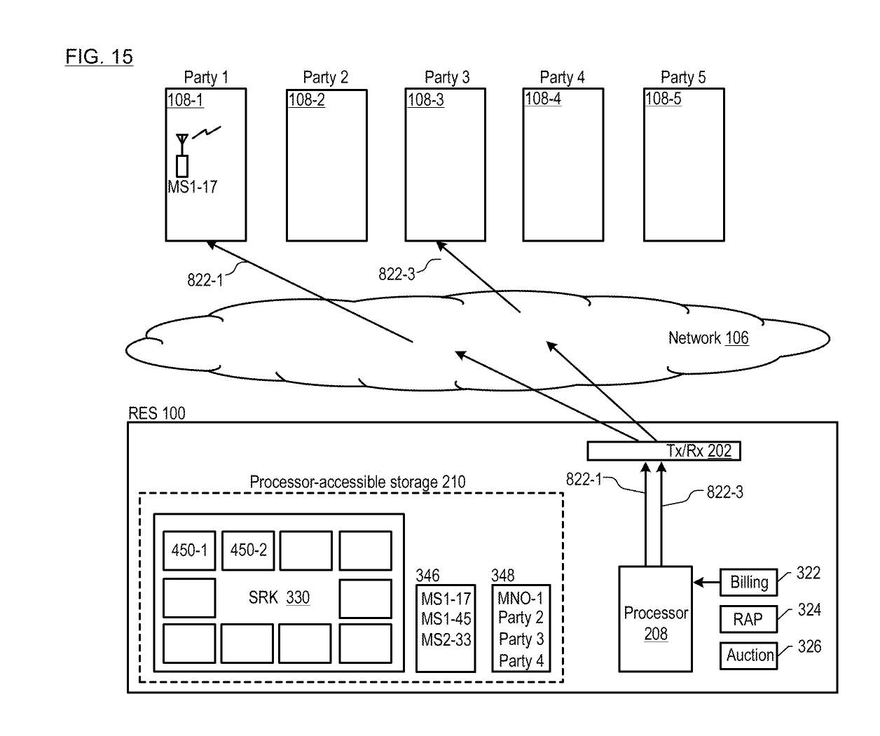

In accordance with the task 934 of FIG. 9, Records Exchange System 100 settles the charges between the Participating Parties 104-1 and 104-2. Settlement of the charges is performed via Billing System 322. As depicted in FIG. 15, signals 822-1 and 822-2, which convey the charge information, are transmitted from Records Exchange System 100 to respective Participating Parties 104-1 and 104-2, per tasks 936 and 938 of FIG. 9.

A number of additional tasks are performed by both Records Exchange System 100 and the Participating Parties that have been visited by a roaming mobile subscriber. These tasks are not germane to the present invention and, as such, are not discussed herein.

It is to be understood that many variations of the invention can easily be devised by those skilled in the art after reading this disclosure and that the scope of the present invention is to be determined by the following claims.

What is claimed is:

1. A records exchange system comprising a data processing system, wherein the data processing system includes:
a transceiver for sending signals to and receiving signals from a first participating party and at least a second participating party, wherein the first participating party is a first mobile network operator; and
a processor, wherein the processor executes the following tasks:
(i) filters selected mobile subscriber data for a first mobile subscriber of the first mobile network operator, wherein the selected mobile subscriber data is filtered using information contained in a first data exchange package applicable to the first mobile subscriber and the second participating party, the filtering thereby generating a first filtered mobile subscriber record; and
(ii) causes the transceiver to transmit one or more first outgoing signals to the second participating party, wherein the first outgoing signal conveys the first filtered mobile subscriber record.

2. The records exchange system of claim 1 wherein the data processing system further comprises processor-accessible storage, wherein the processor-accessible storage contains:
(a) the selected mobile subscriber data for the first mobile subscriber; and
(b) the first data exchange package.

3. The records exchange system of claim 1 and wherein the processor further executes the following tasks:
(iii) filters the selected mobile subscriber data for the first mobile subscriber using information contained in a second data exchange package applicable to the first mobile subscriber and a third participating party, the filtering thereby generating a second filtered mobile subscriber record; and
(iv) causes the transceiver to transmit one or more second outgoing signals to the third participating party, wherein the second outgoing signal conveys the second filtered mobile subscriber record.

4. The records exchange system of claim 3 wherein the data processing system further comprises processor-accessible storage, wherein the processor-accessible storage contains:
(a) the selected mobile subscriber data for the first mobile subscriber;
(b) the first data exchange package; and
(c) the second data exchange package.

5. The records exchange system of claim 4 wherein the second participating party is a mobile network operator and the third participating party is an entity other than a mobile network operator.

6. The records exchange system of claim 1 and wherein the processor further executes the following tasks:
(iii) filters selected mobile subscriber data for a second mobile subscriber of the first mobile network operator using the first data exchange package, the filtering thereby generating a second filtered mobile subscriber record; and
(v) causes the transceiver to transmit one or more second outgoing signals to the second participating party, wherein the second outgoing signal conveys the second filtered mobile subscriber record.

7. The records exchange system of claim 1 and further wherein the processor further executes the following tasks:
(iii) filters selected mobile subscriber data for a second mobile subscriber of the first mobile network operator using a second data exchange package applicable to the second participating party and the second mobile subscriber but not the first mobile subscriber, the filtering thereby generating a second filtered mobile subscriber record; and
(iv) causes the transceiver to transmit one or more second outgoing signals to the second participating party, wherein the second outgoing signal conveys the second filtered mobile subscriber record.

8. The records exchange system of claim 7 wherein the data processing system further comprises processor-accessible storage, wherein the processor-accessible storage contains:
(a) the selected mobile subscriber data for the first mobile subscriber;
(b) the first data exchange package applicable to the first mobile subscriber and the second participating party;
(c) the selected mobile subscriber data for the second mobile subscriber; and
(d) the second data exchange package applicable to the second mobile subscriber and the second participating party, but not applicable to the first mobile subscriber.

9. The records exchange system of claim 1 and further wherein the second participating party is a second mobile network operator.

10. The records exchange system of claim 9 and further wherein the processor further executes the following tasks:
(iii) filters selected mobile subscriber data for a second mobile subscriber of the second mobile network operator using a second data exchange package applicable to the second mobile subscriber and the first participating party, the filtering thereby generating a second filtered mobile subscriber record; and
(iv) causes the transceiver to transmit one or more second outgoing signals to the first participating party, wherein the second outgoing signal conveys the second filtered mobile subscriber record.

11. The mobile subscriber records exchange system of claim 10 wherein the data processing system further comprises processor-accessible storage, wherein the processor-accessible storage contains:
(a) the selected mobile subscriber data for the first mobile subscriber of the first mobile network;
(b) the first data exchange package applicable to the first mobile subscriber of the first mobile network and the second mobile network operator;
(c) the selected mobile subscriber data for the second mobile subscriber of the second mobile network and the first mobile network operator; and
(d) the second data exchange package applicable to the second mobile subscriber of the second mobile network and the first mobile network operator.

12. The mobile subscriber records exchange system of claim 2, wherein the selected mobile subscriber data for the first subscriber is conveyed from the first party to the data processing system via one or more first incoming signals.

13. The mobile subscriber records exchange system of claim 12 wherein the selected mobile subscriber data is encrypted, and further wherein the processor-accessible storage includes a decryption key for decrypting the selected mobile subscriber data.

14. A method for exchanging records, wherein the method comprises:
receiving, at a data processing system, one or more first signals comprising selected mobile subscriber data for a first mobile subscriber from a first participating party;
filtering, in the data processing system, the selected mobile subscriber data using a first data exchange package that is applicable to the first mobile subscriber and a second participating party, thereby generating a first filtered mobile subscriber record;
filtering, in the data processing system, the selected mobile subscriber data using a second data exchange package that is applicable to the first mobile subscriber and a third participating party, thereby generating a second filtered mobile subscriber record;
transmitting, from the data processing system to the second participating party, the first filtered mobile subscriber record via one or more second signals; and
transmitting, from the data processing system to the third participating party, the second filtered mobile subscriber record via one or more third signals.

15. The method of claim 14 and further comprising the task of storing the selected mobile subscriber data in a secure data base in the data processing system.

16. The method of claim 14 and further comprising the task of storing the first data exchange package and the second data exchange package in a data base in the data processing system.

17. The method of claim 14 and further comprising the task of establishing, in processor-accessible storage, a list of participating parties, including the first participating party and the second participating party, wherein the participating parties appearing in the list perform at least one of the following tasks:
(a) send selected mobile subscriber data to the mobile subscriber records exchange;
(b) receive filtered mobile subscriber data from the mobile subscriber records exchange.

18. The method of claim 14 and further comprising the task of:
establishing a list in processor-accessible storage for mobile subscribers who give permission to have selected mobile subscriber data filtered and transmitted to participating parties other than the subscriber's home mobile network operator.

19. The method of claim 14 and further comprising the task of receiving, at the data processing system, at least one or more fourth signals from at least one of either the second participating party or the third participating party, wherein the fourth signal conveys information pertaining to activity of the first mobile subscriber.

20. The method of claim 19 and further comprising the task of updating the selected mobile subscriber data of the first mobile subscriber based on the information conveyed by the fourth signal.

21. The method of claim 19 and further comprising the tasks:
receiving, at the data processing system, at least one or more fourth signals from at least one of the second participating party and the third participating party, wherein the fourth signal conveys a bid for the first filtered mobile subscriber record; and
conducting an auction for the first filtered mobile subscriber record.
